(19) United States
(12) Patent Application Publication
(10) Pub. No.: US 2011/0027561 A1
(43) Pub. Date: Feb. 3, 2011

(54) Optical film structure and display device

(76) Inventors: Cheng-Chieh Chang, Taipei City (TW); Hsiu-Feng Liu, Jhongli City (TW); Pi-Jui Kuo, Jhubei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/458,978

(22) Filed: Jul. 29, 2009

(51) Int. Cl. B32B 7/02

(52) U.S. Cl. 428/216; 428/213

(57) ABSTRACT

An optical film structure includes a substrate and a multi-film structure formed on the substrate. The multi-film structure includes a first refraction-matching layer, a second refraction-matching layer and a third layer. The refraction matching effect of the first and the second refraction-matching layers is produced to lead a phase reversal so as to interfere the incident light and the reflecting light. Therefore, the etched traces cannot be observed by the users so that the image quality of the optical film structure is improved

### BACKGROUND OF THE INVENTION

1. Field of the Invention

The present invention relates to an optical film structure and a display device. In particular, the present invention relates to an optical film structure and a display device with improved quality of images.

2. Description of Related Art

As technology has been developing, the usage of electronic devices increases. Currently, the touch panel (touch-screen) is widely used in electronic products, which is used instead of the traditional keypad so that it is more convenient for directly controlling the devices.

The touch panels are classified into various types of touch panel technology, such as resistive touch panel, capacitive touch panel, infrared touch panel, and ultrasonic-wave touch panel. The resistive touch panel and capacitive touch panel are commonly applied in the application. Capacitive touch screens can support Multitouch technology for easily controlling the system, therefore, the capacitive touch panels are more and more applied in the products. However, the capacitive touch panel only responds to finger contact and will not work with a gloved pen unless the pen is conductive. On the other hand, when an object, such as a finger, or pen, presses down on a point on the resistive touch panel, it causes a change in the electrical current which is registered as a touch event and sent to the controller for processing. In other words, it is easier to control the electronic device by the resistive touch panel. Furthermore, the cost of the resistive touch panel is lower than that of the capacitive touch screens so that the resistive touch panels are applied and developed on the electronic products.

The touch panel is manufactured by coating the glass substrate with a thin, transparent metallic layer. When a user touches the surface, the system records the change in the electrical current to input signals or detect the touched point.

The thin, transparent metallic layer has a circuit thereon by lithography and etching processes so as to form the driving circuit. However, some traces will be formed after the etching process and there is a large difference in the spectrum because the difference of the refraction indexes of the glass substrate and the layer. Therefore, image or shadow is resulted from and causes the lower quality of the display device.

### SUMMARY OF THE INVENTION

One particular aspect of the present invention is to provide an optical film structure. The optical film structure has a first and a second refraction-matching layers on a substrate. The refraction matching effect of the first and the second refraction-matching layers is produced to lead a phase reversal so as to interfere the incident light and the reflecting light. Therefore, the etched traces cannot be observed by the users so that the image quality of the optical film structure is improved.

The optical film structure includes a substrate and a multi-film structure. The multi-film structure includes a first refraction-matching layer, a second refraction-matching layer and a third layer. The first refraction-matching layer is disposed on the substrate and the first refraction-matching layer is an oxide with a lower first refraction index relative to the substrate. The second refraction-matching layer is disposed on the first reflection-matching layer, the second refraction-matching layer is a compound with a higher second refraction index relative to the first refraction-matching layer, and a thickness of the second refraction-matching layer is thicker than a thickness of the first refraction-matching layer. The third layer is disposed on the second refraction-matching layer, and the third layer is an oxide with a higher third refraction index relative to the second refraction-matching layer.

A display device with the optical film structure is further disclosed. The display device is provided for improving the image for the reason of preventing the etched traces from being observed.

The thicknesses and the refraction indexes of the first and the second refraction-matching layers are adjusted to produce a refraction matching effect. Therefore, the optical interference occurs due to the phase reversal. Accordingly, the etched traces cannot be seen so as to improve the image quality.

For further understanding of the present invention, reference is made to the following detailed description illustrating the embodiments and examples of the present invention. The description is for illustrative purpose only and is not intended to limit the scope of the claim.

### BRIEF DESCRIPTION OF THE DRAWINGS

FIG. 1 is a schematic diagram of an optical film structure of the present invention.

### DETAILED DESCRIPTION OF THE PREFERRED EMBODIMENTS

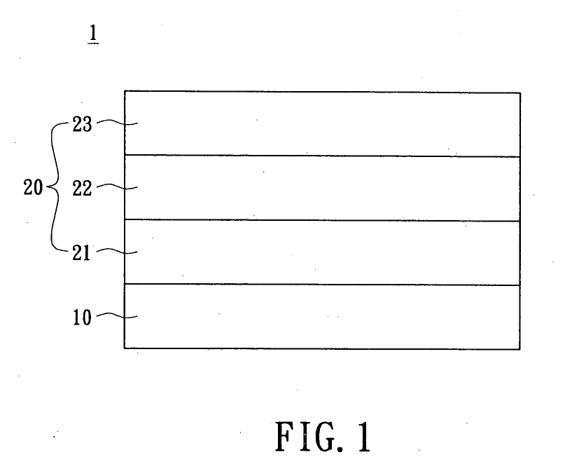

Reference is made to FIG. 1. The present invention provides an optical film structure 1. The optical film structure 1 can be used to perform an optical interference, according to the refraction-matching principle, so as to change the phase reversal of the incident light and the reflecting light. Therefore, the traces by-produced in the etching process cannot be observed by human's eyes so that the optical film structure 1 of the present invention can provide improved image quality. The optical film structure 1 has a substrate 10 and a multi-film structure 20 stacked on the substrate 10. The multi-film structure 20 includes a first refraction-matching layer 21, a second refraction-matching layer 22 and a third layer 23. The three layers are orderly stacked on the substrate 10. In other words, the first refraction-matching layer 21 is most adjacent to the substrate 10 and the third layer 23 is most far away from the substrate 10.

The arrangement of refraction indexes of the first refraction-matching layer 21, a second refraction-matching layer 22 and a third layer 23 lead the phase reversal of the incident light and the reflecting light so that the traces formed in the etching process cannot be observed by human's eyes. The indexes and the thickness are shown below. The first refraction-matching layer 21 is formed on the substrate 10 and the first refraction-matching layer 21 is an oxide with a lower first refraction index relative to the substrate 10. The second refraction-matching layer 22 is formed on the first reflection-matching layer 21. The second refraction-matching layer 22 is a compound with a higher second refraction index relative to the first refraction-matching layer 21, and a thickness of the second refraction-matching layer 22 is thicker than a thickness of the first refraction-matching layer 21. The third layer 23 is formed on the second refraction-matching layer 22, and the third layer 23 is an oxide with a higher third refraction index relative to the second refraction-matching layer 22.

Four embodiments are shown in Table. 1, but not restricted thereby.

| embodiment | layer | material | thickness(Å) |
|---|---|---|---|
| (1) | third layer | ITO | 180 |
| | second refraction- | SiO2 | 700 |
| | matching layer | | |
| | first reflection- | Nb2O5 | 100 |
| | matching layer | | |
| (2) | third layer | ITO | 180 |
| | second refraction- | SiO2 | 660 |
| | matching layer | | |
| | first reflection- | TiO2 | 80 |
| | matching layer | | |
| (3) | third layer | ITO | 180 |
| | second refraction- | MgF2 | 700 |
| | matching layer | | |
| | first reflection- | TiO2 | 70 |
| | matching layer | | |
| (4) | third layer | ITO | 180 |
| | second refraction- | MgF2 | 650 |
| | matching layer | | |
| | first reflection- | Nb2O5 | 70 |
| | matching layer | | |

Reference is made to embodiment (1) of the present invention. The substrate 10 is made of glass material, but not restricted thereby. For example, the substrate 10 can be PC (polycarbonate), PMMA (polymethyl methacrylate), PET (polyethylene terephthalate), ARTON, and so on. Furthermore, the refraction index of the substrate 10 is about 1.52.

The first refraction index of the first reflection-matching layer 21 is about 1.49. In other words, the first refraction index is lower than the refraction index of the substrate 10. Moreover, the first refraction-matching layer 21 is made of Nb2O5 material and the thickness of the first refraction-matching layer 21 is about 100 angstrom.

The second refraction index of the second refraction-matching layer 22 is about 1.58. In other words, the second refraction index of the second refraction-matching layer 22 is higher than the first refraction index of the first refraction-matching layer 21. The second refraction-matching layer 22 is made of MgF2 material and the second refraction-matching layer 22 has a thickness of about 700 angstrom. Accordingly, the thickness of the second refraction-matching layer 22 is thicker than the thickness of the first refraction-matching layer 21. Furthermore, the refraction index of the substrate 10 (1.52) is between the first fraction index (1.49) of the first refraction-matching layer 21 and the second fraction index (1.58) of the second refraction-matching layer 22.

The third layer 23 of the first embodiment has a refractive index of about 2.0. In other words, the refraction index of the third layer 23 is higher than the second refraction index of the second refraction-matching layer 22. On the other hand, the third layer 23 is made of ITO material and the thickness of the third layer 23 is about 180 angstrom. The third layer 23 is a surface layer and the high refraction index of the surface layer is between 1.9 and 2.1. The materials of the surface layer can be SnO2, ZnO2, In2O3, or ITO. Moreover, the third layer 23 preferably has conductivity so that the grounding process can be improved and the yield can be increased. Because of the conductivity of the third layer 23, the electrode can be formed efficiently on the third layer 23. Therefore, the present invention can be applied for the application of the touch panel.

Depending on the optical effect of the first refraction-matching layer 21 and the second refraction-matching layer 22, the phase reversal effect is achieved so as to perform an optical interference. Therefore, the formed traces in the etching process cannot be observed by human's eyes. To sum up, the first refraction-matching layer 21 which has lower refraction index than the substrate 10, and the second refraction-matching layer 22 which has higher refraction index than the first refraction-matching layer 21 and has thicker thickness than the first refraction-matching layer 21 are employed to match the optical property so that the formed traces in the etching process cannot be observed by human's eyes. Furthermore, the quality of the optical film structure 1 is improved.

According to the embodiments of Table. 1, the optical film structure 1 has the following structures. The substrate 10 is made of glass material and the substrate 10 of glass has a refraction index of 1.52. The first refraction-matching layer 21 has a lower first refraction index relative to the substrate 10. In an embodiment, the first refraction-matching layer 21 is made of Nb2O5 material, and the first refraction index and the thickness of the first refraction-matching layer 21 are respectively 1.49 and of from 70 to 100 angstrom. Alternatively, the first refraction-matching layer 21 is made of TiO2 material, and the thickness of the first refraction-matching layer 21 is of from 70 to 80 angstrom. The second refraction-matching layer 22 has a higher second refraction index relative to the first refraction-matching layer 21, and the thickness of the second refraction-matching layer 22 is thicker than that of the first refraction-matching layer 21. The second refraction index of the second refraction-matching layer 22 is about 1.58. The second refraction-matching layer 22 can be made of MgF2 material and has thickness of about 660 to 700 angstrom. Alternatively, the second refraction-matching layer 22 can be made of SiO2 material and has thickness of about 660 to 700 angstrom. The third layer 23 has a higher third refraction index relative to the second refraction-matching layer 22. The third refraction index of the third layer 23 is about 2.0 and the third layer 23 can be made of ITO material.

Moreover, the optical film structure 1 can be used in display units, such as LCD, CRT, touch panel and other devices having such display units.

The present invention has the following characteristics.

1. The refraction matching effect of the first and the second refraction-matching layers is produced to lead a phase reversal so as to interfere the incident light and the reflecting light. Therefore, the etched traces cannot be observed by the users so that the image quality of the optical film structure is improved.

The description above only illustrates specific embodiments and examples of the present invention. The present invention should therefore cover various modifications and variations made to the herein-described structure and operations of the present invention, provided they fall within the scope of the present invention as defined in the following appended claims.

What is claimed is:

1. An optical film structure, comprising: a substrate and a multi-film structure, the multi-film structure including a first refraction-matching layer, a second refraction-matching layer and a third layer, wherein,
the first refraction-matching layer is disposed on the substrate, and the first refraction-matching layer is an oxide with a lower first refraction index relative to the substrate,
the second refraction-matching layer is disposed on the first reflection-matching layer, the second refraction-matching layer is a compound with a higher second refraction index relative to the first refraction-matching layer, and a thickness of the second refraction-matching layer is thicker than a thickness of the first refraction-matching layer,
the third layer is disposed on the second refraction-matching layer, and the third layer is an oxide with a higher third refraction index relative to the second refraction-matching layer.

2. The optical film structure as claimed in claim 1, wherein the substrate is made of glass material.

3. The optical film structure as claimed in claim 2, wherein the substrate of glass has a refraction index of 1.52.

4. The optical film structure as claimed in claim 3, wherein the first refraction index of the first refraction-matching layer is 1.49.

5. The optical film structure as claimed in claim 4, wherein the first refraction-matching layer is made of Nb2O5 material, and the first refraction-matching layer has a thickness of from 70 to 100 angstrom.

6. The optical film structure as claimed in claim 4, wherein the first refraction-matching layer is made of TiO2 material, and the first refraction-matching layer has a thickness of from 70 to 80 angstrom.

7. The optical film structure as claimed in claim 4, wherein the second refraction index of the second refraction-matching layer is about 1.58.

8. The optical film structure as claimed in claim 7, wherein the second refraction-matching layer is made of MgF2 material, and the second refraction-matching layer has a thickness of from 660 to 700 angstrom.

9. The optical film structure as claimed in claim 7, wherein the second refraction-matching layer is made of SiO2 material, and the second refraction-matching layer has a thickness of from 660 to 700 angstrom.

10. The optical film structure as claimed in claim 7, wherein the third refraction index of the third layer is about 2.0.

11. The optical film structure as claimed in claim 10, wherein the third layer is made of ITO material, and the third layer has a thickness of 180 angstrom.

12. The optical film structure as claimed in claim 1, wherein the substrate has a refraction index between the first fraction index of the first refraction-matching layer and the second fraction index of the second refraction-matching layer.

13. A display device having the optical film structure as claimed in claim 1.
